(19) United States
(12) Patent Application Publication
(10) Pub. No.: US 2026/0323198 A1
(43) Pub. Date: Oct. 15, 2026

(54) ELECTRONIC DEVICE INCLUDING ACOUSTIC MODULE

(71) Applicant: Samsung Electronics Co., Ltd., Suwon-si (KR)

(72) Inventors: Daehee NAM, Suwon-si (KR); Myungsub KO, Suwon-si (KR); Sunghyup LEE, Suwon-si (KR)

(21) Appl. No.: 19/644,212

(22) Filed: Apr. 10, 2026

Related U.S. Application Data
(63) Continuation of application No. PCT/KR2026/004510, filed on Mar. 20, 2026.

(30) Foreign Application Priority Data
Apr. 11, 2025 (KR) 10-2025-0047488
May 14, 2025 (KR) 10-2025-0062301

(51) Int. Cl. H04R 1/08; H04R 1/02

(52) U.S. Cl. CPC H04R 1/086; H04R 1/028; H04R 2499/11

(57) ABSTRACT

An electronic device may include a first cover closing a first opening of a housing and including a first through hole, a substrate disposed in the housing and having a third surface facing the second surface and a fourth surface opposite to the third surface and including a second through hole aligned with the first through hole, a first electrical component disposed on the substrate and connected outside of the electronic device through the first and second through holes, a compressible sealing member disposed between the third surface and the second surface surrounding the first and second through holes, and a metal plate at least partially disposed between the compressible sealing member and the second surface and including a third through hole aligned with the first and second through holes, and the first electrical component may be connected outside the electronic device through the first, second, and third through holes.

### CROSS-REFERENCE TO RELATED APPLICATIONS

This application is a continuation of International Application No. PCT/KR2026/004510 designating the United States, filed on Mar. 20, 2026, in the Korean Ministry of Intellectual Property Receiving Office and claiming priority to Korean Patent Application Nos. 10-2025-0047488, filed on Apr. 11, 2025, and 10-2025-0062301, filed on May 14, 2025, in the Korean Ministry of Intellectual Property, the disclosures of each of which are incorporated by reference herein in their entireties.

### BACKGROUND

### Field

The disclosure relates to an electronic device including an acoustic module.

### Description of Related Art

An electronic device is gradually being slimmed, and is being developed in order to increase rigidity of the electronic device, and to reinforce a design aspect, and at the same time to differentiate a functional element.

Electrical components, such as an acoustic module (e.g., a microphone or a speaker), disposed in an internal space of the electronic device should be efficiently disposed such that slimming of the electronic device may be helped. In addition, even if the electrical components are efficiently disposed in the internal space of the electronic device, if a function of the electrical components is not properly expressed, a degradation in quality of the electronic device may be caused, so there is a need for the electronic device to be developed so as to satisfy all such conditions.

The information described above may be provided as the related art for the purpose of enhancing the understanding of the present disclosure. No assertion or determination is made with respect to the applicability of any of the above-mentioned as the prior art related to the present disclosure.

An electronic device may include at least one electrical component disposed such that a function may be sufficiently exhibited at a proper place in an internal space. Such at least one electrical component may include at least one of a printed circuit board, a display, various elements, various sensors, or at least one acoustic module. The acoustic module may include a microphone for collecting sound generated outside the electronic device or a speaker for emitting sound to an outside of the electronic device.

The acoustic module may be disposed together with a peripheral electrical component (e.g., a camera module) for an efficient disposition design in an interior of the electronic device. For example, the electrical component may include at least one camera module configured to be exposed to an outside of the electronic device. The acoustic module may be disposed to be connected with the outside of the electronic device through at least a part of a cover member (e.g., a decorative or ornamental member) for installing the camera module. In such a case, the acoustic module and the cover member may have a laminated structure, and, due to a characteristic of the acoustic module, for improving acoustic performance, a plurality of laminated members (e.g., a sealing member or a tape member) may be disposed. Such a laminated structure may be considered as very important elements in a slimming design of the electronic device. Further, since the cover member disposed for the camera module is disposed such that the cover member is caught on an inner surface of a case frame (e.g., a rear surface cover) of the electronic device through a flange structure, the flange structure of the cover member as well may increase a thickness of the electronic device, thereby running counter to slimming of the electronic device.

Since the electronic device is designed by considering a thickness of the cover member supporting the camera module, a thickness of a sealing sponge disposed on a substrate (e.g., a compressible sealing member), and an injection bracket pressing to suppress a repulsive property of the sponge, thereby causing problems of running counter to slimming of the electronic device. In addition, when the cover member and a filter member (mesh) shielding a through hole of the cover member are disposed on the same plane, since an adhesion surface area of an adhesive member (e.g., a tape member) disposed side by side with the filter member is reduced, waterproof performance is degraded, and a possibility of peeling of the cover member may be increased.

### SUMMARY

Embodiments of the disclosure may provide an electronic device including an acoustic module having a disposition structure capable of helping slimming of a device.

Embodiments of the disclosure may provide an electronic device including an acoustic module having a disposition structure for improving waterproof performance.

Embodiments of the disclosure may provide an electronic device including an acoustic module having a disposition structure for improving acoustic performance.

However, the object to be achieved by the present disclosure is not limited to the above-mentioned objects but may be variously expanded without departing from the technical teachings and scope of the present disclosure.

According to various example embodiments, an electronic device may include: a housing including a first opening, a first cover attached to an outer surface of the housing and configured to close the first opening and including a first through hole formed from a first surface facing an outside of the housing to a second surface opposite to the first surface, a substrate disposed in the housing and including a second through hole formed from a third surface facing the second surface to a fourth surface opposite to the third surface, the second through hole being aligned with the first through hole, a first electrical component disposed on the substrate and connected with an outside of the electronic device through the first through hole and the second through hole, a compressible sealing member disposed between the third surface and the second surface to surround the first through hole and the second through hole, and a metal plate disposed at least partially between the compressible sealing member and the second surface and including a third through hole aligned with the first through hole and the second through hole, wherein the first electrical component may be connected with an outside of the electronic device through the first, second, and third through holes.

According to various example embodiments, an electronic device may include: a housing including a first opening, a first cover attached to an outer surface of the housing to close the first opening and including a first through hole formed from a first surface facing an outside of the housing to a second surface opposite to the first surface, a substrate disposed in the housing and including a second through hole formed from a third surface facing the second surface to a fourth surface opposite to the third surface, the second through hole aligned with the first through hole, a first electrical component disposed on the substrate and connected with an outside of the electronic device through the first through hole and the second through hole, and a compressible sealing member disposed between the third surface and the second surface to surround the first through hole and the second through hole, wherein the first electrical component may be connected with an outside of the electronic device through the first through hole and the second through hole.

An electronic device according to various example embodiments of the present disclosure may, in order to press a compressible sealing member disposed between a substrate and a cover (e.g., a decorative member), by having a disposition structure (e.g., a laminated structure) including a thin metal plate disposed between the compressible sealing member and the substrate and fixed to the substrate, help slimming of the electronic device. By disposing a filter member and an adhesive member attaching the cover to the metal plate on different surfaces of the cover and by expanding an adhesion area of the adhesive member, such may help securing waterproof performance through improvement of a sealing function.

In addition, various effects that can be directly or indirectly identified through the present document may be provided.

The effects obtained by the present disclosure are not limited to the aforementioned effects, and other effects, which are not mentioned above, will be clearly understood by those skilled in the art to which the present disclosure pertains from the following description.

### BRIEF DESCRIPTION OF THE DRAWINGS

In connection with the description of the drawings, the same or similar reference numerals may be used for the same or similar elements. Further, the above and other aspects, features and advantages of certain embodiments of the present disclosure will be more apparent from the following detailed description, taken in conjunction with the accompanying drawings, in which:

FIG. 1 is a front perspective view of an example electronic device according to various example embodiments.

FIG. 2 is a rear perspective view of the electronic device of FIG. 1 according to various example embodiments.

FIG. 3 is an exploded perspective view of the electronic device of FIG. 2 according to various example embodiments.

FIG. 4A is an exploded perspective view of a cover member mounted on a rear surface cover according to various example embodiments.

FIG. 4B is an exploded perspective view of a substrate and a metal plate according to various example embodiments.

FIG. 4C is a diagram illustrating a part of a rear surface of an electronic device according to various example embodiments.

FIG. 5 is a partial perspective view illustrating a state in which the cover member is mounted on the rear surface cover of the electronic device according to various example embodiments.

FIG. 6A is a partial cross-sectional view of the electronic device shown along line 6-6 of FIG. 5 according to various example embodiments.

FIG. 6B is a partial cutaway perspective view of the electronic device shown along line 6-6 of FIG. 5 according to various example embodiments.

FIG. 6C is a perspective view of a compressible sealing member according to various example embodiments.

FIG. 7A is a diagram illustrating a part of a rear surface of an electronic device according to various example embodiments.

FIG. 7B is a partial cross-sectional view of the electronic device illustrating a laminated structure of a microphone of FIG. 7A according to various example embodiments.

FIG. 8 is a partial cross-sectional view of an electronic device according to various example embodiments.

FIG. 9A is a diagram illustrating example disposition of a tape member and a filter member according to various example embodiments.

FIG. 9B is a partial cross-sectional view of an electronic device in which the tape member and the filter member of FIG. 9A are disposed according to various example embodiments.

FIG. 10 is a block diagram of an example electronic device in a network environment according to various example embodiments.

### DETAILED DESCRIPTION

The following description with reference to the accompanying drawings is provided to assist in understanding of various example embodiments of the disclosure. It includes various specific details to assist in that understanding but these are to be regarded as merely examples. Accordingly, those skilled in the art will recognize that various changes and modifications of the various embodiments described herein can be made without departing from the scope and spirit of the disclosure. In addition, descriptions of well-known functions and constructions may be omitted for clarity and conciseness.

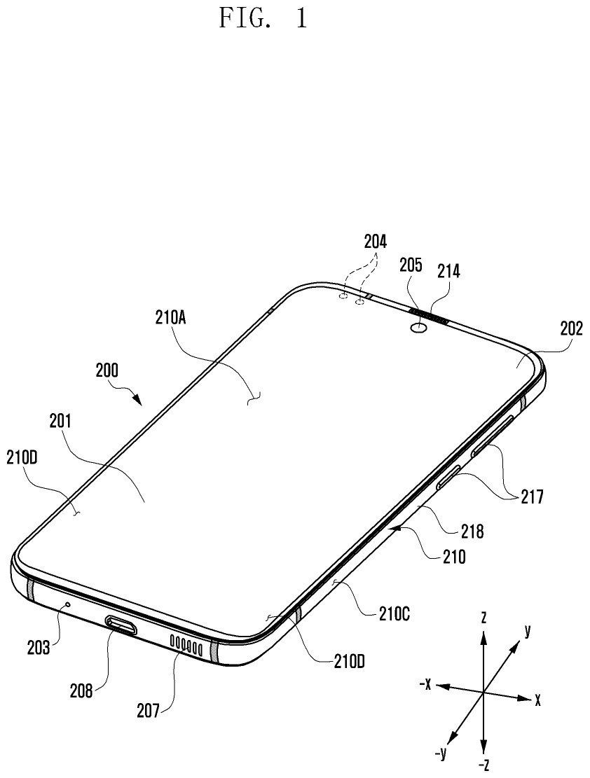

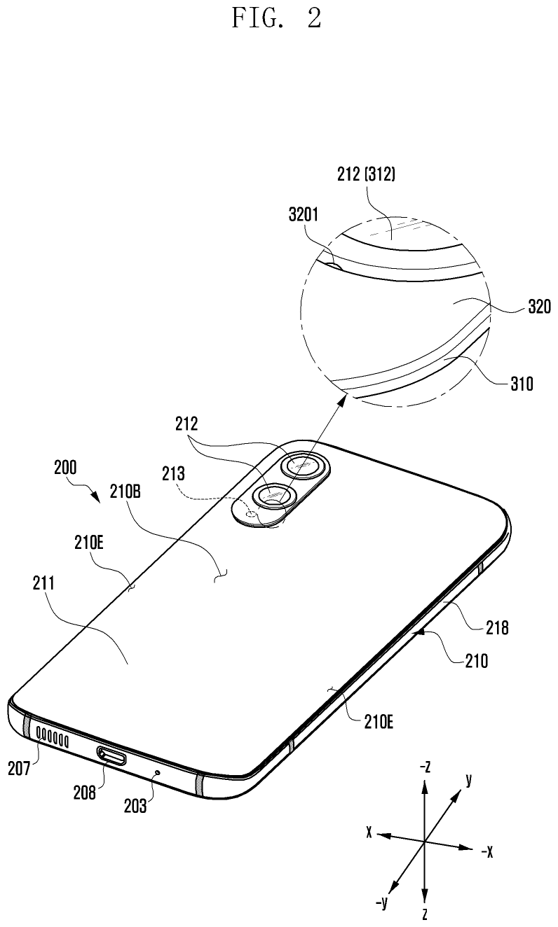

FIG. 1 is a front perspective view of an example electronic device 200 according to various example embodiments. FIG. 2 is a rear perspective view of a rear surface of the electronic device 200 shown in FIG. 1 according to various example embodiments.

Referring to FIGS. 1 and 2, the electronic device 200 may include a housing 210 that includes a first surface (or front surface) 210A, a second surface (or rear surface) 210B, and a lateral surface 210C that surrounds a space between the first surface 210A and the second surface 210B. The housing 210 may refer to a structure that forms a part of the first surface 210A, the second surface 210B, and the lateral surface 210C. The first surface 210A may be formed of a front plate 202 (e.g., a glass plate or polymer plate coated with a variety of coating layers) at least a part of which is substantially transparent. The second surface 210B may be formed of a rear plate 211 which is substantially opaque. The rear plate 211 may be formed of, for example, coated or colored glass, ceramic, polymer, metal (e.g., aluminum, stainless steel (STS), or magnesium), or any combination thereof. The lateral surface 210C may be formed of a lateral bezel structure (or “lateral member”) 218 which is combined with the front plate 202 and the rear plate 211 and includes a metal and/or polymer. The rear plate 211 and the lateral bezel structure 218 may be integrally formed and may be of the same material (e.g., a metallic material such as aluminum).

The front plate 202 may include two first regions 210D disposed at long edges thereof, respectively, and bent and extended seamlessly from the first surface 210A toward the rear plate 211. Similarly, the rear plate 211 may include two second regions 210E disposed at long edges thereof, respectively, and bent and extended seamlessly from the second surface 210B toward the front plate 202. The front plate 202 (or the rear plate 211) may include only one of the first regions 210D (or of the second regions 210E). The first regions 210D or the second regions 210E may be omitted in part. When viewed from a lateral side of the electronic device 200, the lateral bezel structure 218 may have a first thickness (or width) on a lateral side where the first region 210D or the second region 210E is not included, and may have a second thickness, being less than the first thickness, on another lateral side where the first region 210D or the second region 210E is included.

The electronic device 200 may include at least one of a display 201, audio modules 203, 207 and 214, sensor module 204, camera modules 205, 212 and 213, a key input device 217, a light emitting device, and connector holes 208 and 209. The electronic device 200 may omit at least one (e.g., the key input device 217 or the light emitting device) of the above components, or may further include other components.

The display 201 may be visible through a substantial portion of the front plate 202, for example. At least a part of the display 201 may be visible through the front plate 202 that forms the first surface 210A and the first region 210D of the lateral surface 210C. The display 201 may be combined with, or adjacent to, a touch sensing circuit, a pressure sensor capable of measuring the touch strength (pressure), and/or a digitizer for detecting a stylus pen. At least a part of the sensor module 204 and/or at least a part of the key input device 217 may be disposed in the first region 210D and/or the second region 210E.

According to various embodiments, the input device 203 may include at least one microphone. In various embodiments, the input device 203 may include a plurality of microphones disposed to detect the direction of a sound. According to an embodiment, the sound output devices may include speakers. According to an embodiment, the input device 203 may include a receiver for calls disposed in the first housing 210, and a speaker. In various embodiments, the input device 203, the sound output devices, and the connector port 208 may be disposed in a space arranged in the first housing 210 and/or the second housing 220 of the electronic device 200, and may be exposed to the external environment through at least one hole formed in the first housing 210 and/or the second housing 220. In various embodiments, the sound output devices may include a speaker (e.g., piezo speaker) that operates without using a hole formed in the first housing 210 and/or the second housing 220. In various embodiments, the electronic device 200 may include a tray member disposed through at least a portion of the lateral bezel structure 218.

The sensor module 204 may generate electrical signals or data corresponding to an internal operating state of the electronic device 200 or to an external environmental condition. The sensor module 204 may include a first sensor module 204 (e.g., a proximity sensor) and/or a second sensor module (e.g., a fingerprint sensor) disposed on the first surface 210A of the housing 210, and/or a third sensor module (e.g., a heart rate monitor (HRM) sensor) and/or a fourth sensor module (e.g., a fingerprint sensor) disposed on the second surface 210B of the housing 210. The fingerprint sensor may be disposed on the second surface 210B as well as the first surface 210A (e.g., the display 201) of the housing 210. The electronic device 200 may further include at least one of a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor 204.

The camera modules 205, 212 and 213 may include a first camera device 205 disposed on the first surface 210A of the electronic device 200, and a second camera device 212 and/or a flash 213 disposed on the second surface 210B. The camera module 205 or the camera module 212 may include one or more lenses, an image sensor, and/or an image signal processor. The flash 213 may include, for example, a light emitting diode or a xenon lamp. Two or more lenses (infrared cameras, wide angle and telephoto lenses) and image sensors may be disposed on one side of the electronic device 200.

The key input device 217 may be disposed on the lateral surface 210C of the housing 210. The electronic device 200 may not include some or all of the key input device 217 described above, and the key input device 217 which is not included may be implemented in another form such as a soft key on the display 201. The key input device 217 may include the sensor module disposed on the second surface 210B of the housing 210.

The indicator may be disposed on the first surface 210A of the housing 210. For example, the indicator may provide status information of the electronic device 200 in an optical form. The indicator may provide a light source associated with the operation of the camera module 205. The indicator may include, for example, a light emitting diode (LED), an IR LED, or a xenon lamp.

The connector hole 208 may include a first connector hole 208 adapted for a connector (e.g., a USB connector) for transmitting and receiving power and/or data to and from an external electronic device, and/or a second connector hole adapted for a connector (e.g., an earphone jack) for transmitting and receiving an audio signal to and from an external electronic device.

Some camera modules 205 of camera modules 205 and 212, sensor module 204, or an indicator may be arranged to be exposed through a display 201. For example, the camera module 205, the sensor module 204, or the indicator may be arranged in the internal space of an electronic device 200 so as to be brought into contact with an external environment through an opening of the display 201, which is perforated up to a front plate 202. According to an embodiment, an area corresponding to some camera module 105 of the display 201 is a part of an area in which content is displayed, and may be formed as a transmission area having designated transmittance. For example, the transmission area may be formed to have transmittance having a range of about 5% to about 20%. The transmission area may include an area overlapped with a valid area (e.g., a field of view (FOV)) of the camera module 105 through which light imaged by an image sensor and for generating an image passes. For example, a transmission area of the display 201 may include an area in which the density of pixels and/or a wiring density are lower than that of surroundings. The camera module 205 may include, for example, under display camera (UDC). In an embodiment, some sensor modules 204 may be arranged to perform their functions without being visually exposed through the front plate 202 in the internal space of the electronic device. For example, in this case, an area of the display 201 facing the sensor module may not require a perforated opening.

According to various embodiments, an electronic device 200 may include a pair of camera modules 212 exposed to an outside through a rear surface plate 211 (e.g., a rear surface cover). In an embodiment, the camera module 212 may be covered through a first cover 310 attached to an outer surface of the rear surface plate 211. In an embodiment, at least a part of the first cover 310 may be formed of a transparent material (e.g., glass or acrylic) in order to receive external light. In an embodiment, the electronic device 200 may include a second cover 320 disposed in a manner of being laminated on the first cover 310.

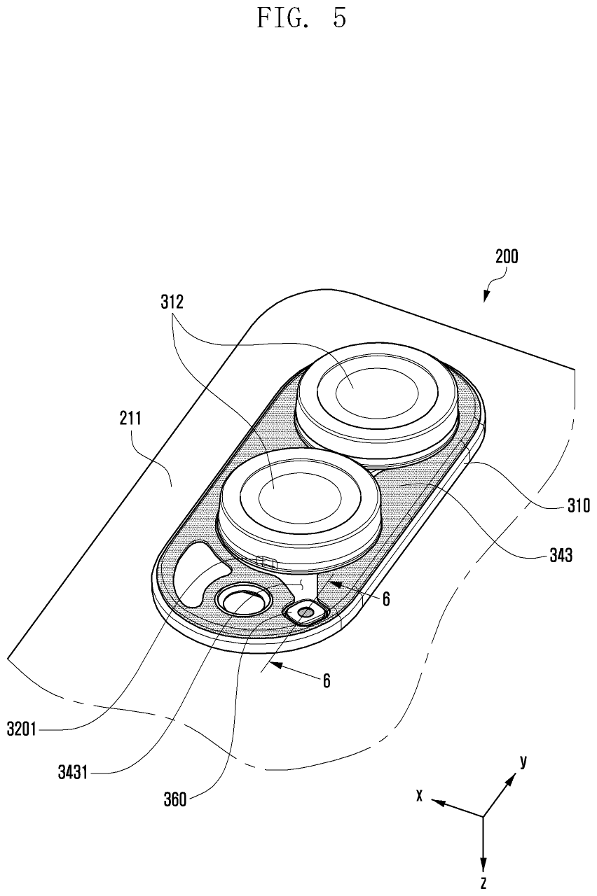

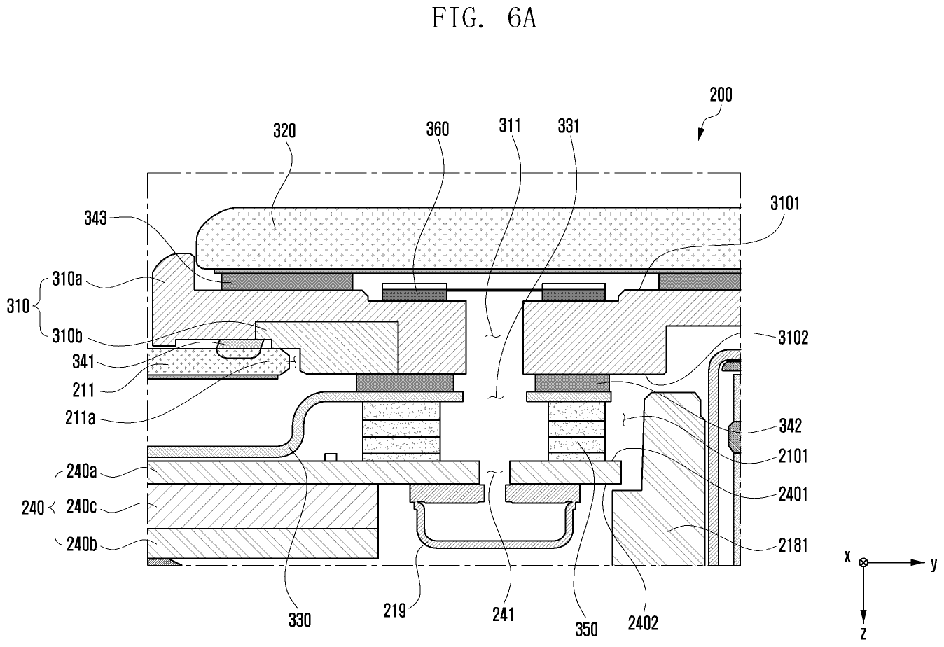

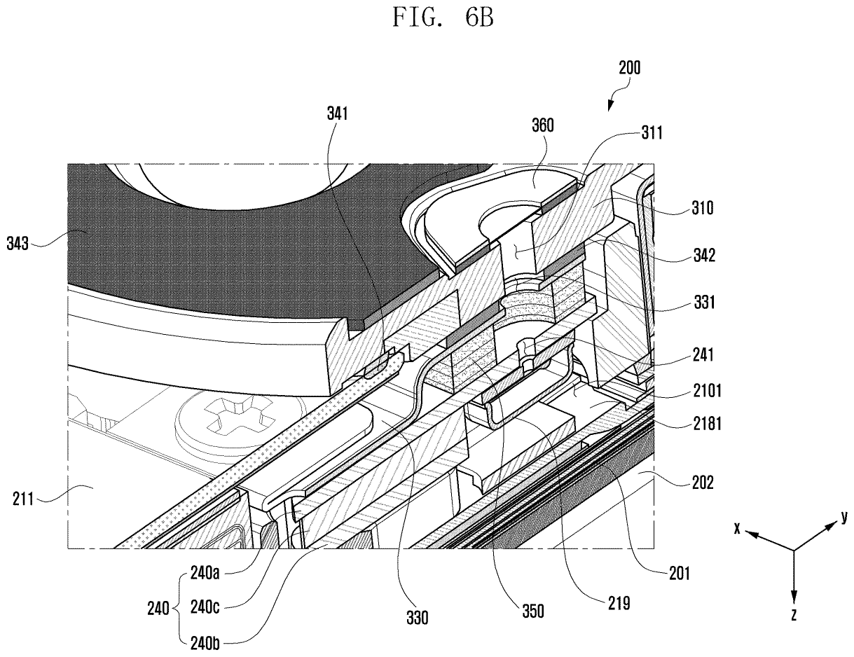

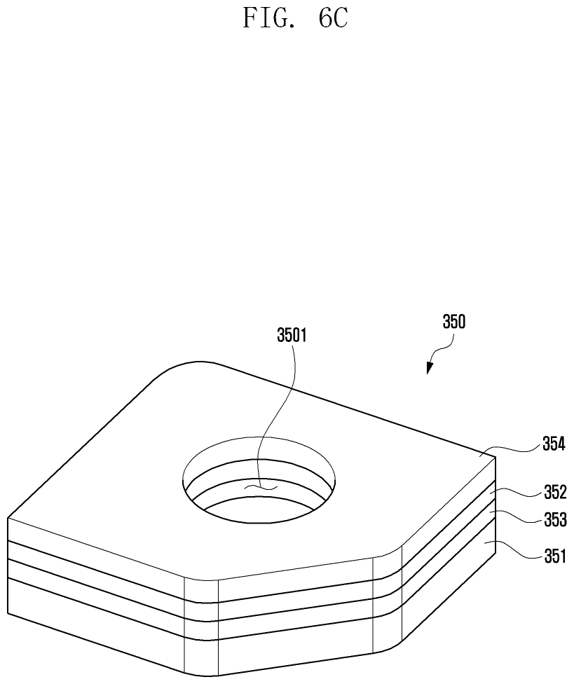

According to various embodiments, the electronic device 200 may include a microphone (e.g., a microphone 219 of FIG. 6A) disposed through a laminated structure of the first cover 310. In an embodiment, the microphone 219 may be disposed to collect external sound through a space 3201 formed in a coupling portion of the first cover 310 and the second cover 320 and through a path 3431 formed through a shape of a tape member (e.g., a second tape member 343 of FIG. 5) attaching the first cover and the second cover. In an embodiment, the microphone 219 may also be replaced with a speaker for emitting sound to an outside through the space 3201. In an embodiment, the microphone 219 may also be replaced with an external environment detection sensor, such as a barometric pressure sensor or an odor sensor, set to detect an external environment of the electronic device 200 through the space 3201.

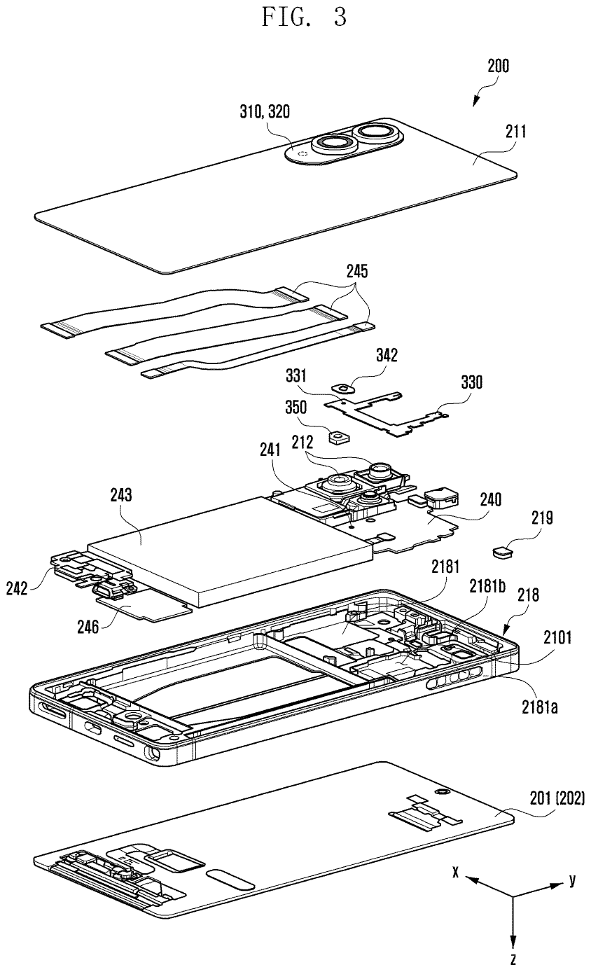

FIG. 3 is an exploded perspective view of the electronic device of FIG. 2 according to various example embodiments.

With reference to FIG. 3, the electronic device 200 (e.g., a portable communication device) may include a lateral member 218 (e.g., a side surface bezel structure or a side surface frame), a support member 2181 (e.g., a bracket, an extension member, or a support structure) extended from the lateral member 218 to an internal space 2101 of the electronic device 200, a front surface cover 202 (e.g., a front surface plate, a first plate, or a first cover) coupled to one side 2181a of the support member 2181, and a rear surface cover 211 (e.g., a rear surface plate, a second plate, a cover member, or a second cover) coupled to the other side 2181b of the support member 2181 to face an opposite direction from the front surface cover 202. In an embodiment, the electronic device 200 may include a housing (e.g., the housing 210 of FIG. 2) (e.g., a housing structure) formed through coupling of the lateral member 218, the front surface cover 202, and/or the rear surface cover 211. In an embodiment, the electronic device 200 may include a display 201 disposed in the internal space 2101, a substrate 240, the camera module 212 disposed on the substrate 240, a battery 243, a sub substrate 246 disposed to be spaced apart from the substrate 240 with the battery 243 interposed therebetween, and a module assembly 242 (e.g., a speaker assembly, a microphone assembly, or an interface connector assembly) electrically connected to the substrate 240 and/or the sub substrate 246. In an embodiment, at least one among the above-described elements may be omitted, or at least one among other elements may be additionally included. At least one among elements of the electronic device 200 may be the same as, or similar to, at least one among elements of an electronic device 101 of FIG. 1 or the electronic device 200 of FIG. 2, and redundant descriptions may not be repeated here.

According to various embodiments, the support member 2181 may be disposed in an interior of the electronic device 200, and may be connected to the lateral member 218, or may be integrally formed with the lateral member 218. The lateral member 218 and/or the support member 2181 may be formed of, for example, a metal material and/or a non-metal material (e.g., a polymer material). In an embodiment, the display 201 may be coupled to receive support of one side 2181a of the support member 2181, and the substrate 240, the sub substrate 246, the module assembly 242, and the battery 243 may be disposed to receive support of the other side 2181b facing an opposite direction from one side 2181a. The electronic device 200 may include a processor, a memory, and/or an interface disposed on the substrate 240. The processor may include, for example, one or more of a central processing unit, an application processor, a graphics processing unit, an image signal processor, a sensor hub processor, and/or a communication processor.

The memory may include, for example, a volatile memory or a non-volatile memory.

An interface may include, for example, high definition multimedia interface (HDMI), a universal serial bus (USB) interface, a secure digital (SD) card interface, and/or an audio interface. The interface may, for example, electrically or physically connect an electronic device 200 with an external electronic device, and may include a USB connector, an SD card/multimedia card (MMC) connector, or an audio connector.

The battery 243 is a device for supplying power to at least one element of the electronic device 120, and may include, for example, a non-rechargeable primary battery, or a rechargeable secondary battery, or a fuel cell. At least a part of the battery 243 may, for example, be disposed side by side to be located on substantially the same plane as the substrate 240 and/or the sub substrate 246. The battery 243 may be built in an interior of the electronic device 200. In an embodiment, the battery 243 may also be disposed to be detachable from the electronic device 200.

According to various embodiments, the electronic device 200 may include at least one electrical connection device 245 for electrically connecting the substrate 240 and the sub substrate 246, and/or the substrate 240 and the module assembly 242. In an embodiment, the at least one electrical connection device 245 may include a flexible printed circuit board (FPCB).

According to various embodiments, the electronic device 200 may include a microphone 219 disposed on a rear surface of the substrate 240 (e.g., a fourth surface 2402 of FIG. 6A). In an embodiment, the microphone 219 may be disposed to be aligned with a through hole (e.g., a second through hole 241 of FIG. 6A) penetrated (or passed through) from the rear surface of the substrate 240 to a front surface (e.g., a third surface 2401 of FIG. 6A). In an embodiment, the electronic device 200 may include a through hole (e.g., a third through hole 331 of FIG. 6A) for being aligned with the through hole 241 of the substrate 240, and may include a metal plate 330 fixed to the front surface of the substrate 240. In an embodiment, the electronic device 200 may include a compressible sealing member (or seal) 350 (e.g., a sponge) disposed between the metal plate 330 and the substrate 240 and sealing to surround through holes 241 and 331. In an embodiment, the metal plate 330 may, in order to maintain sealing force of the compressible sealing member 350, be fixed to the substrate 240 through a fastening member such as a screw, and may press the compressible sealing member 350 in a substrate direction (e.g., a z-axis direction). Such sealing force may help reduction of a sound leakage phenomenon of sound transmitted to the microphone 219. In an embodiment, the metal plate 330 may be attached to an outer surface of the rear surface cover 211, and may be coupled, through a first opening (e.g., a first opening 211a of FIG. 6A) of the rear surface cover 211, with the first cover 310 exposed to the internal space 2101 of the electronic device 200, through a tape member 342 (e.g., a first tape member 342 of FIG. 6A).

An electronic device 200 according to an example embodiment of the present disclosure may, as the first cover 310 is attached to an outer side of the rear surface cover 211, exclude a flange structure caught on an inner side of the rear surface cover 211, and, as a pressing means that presses the compressible sealing member 350, use a thin metal plate 330, thereby help slimming of the electronic device 200.

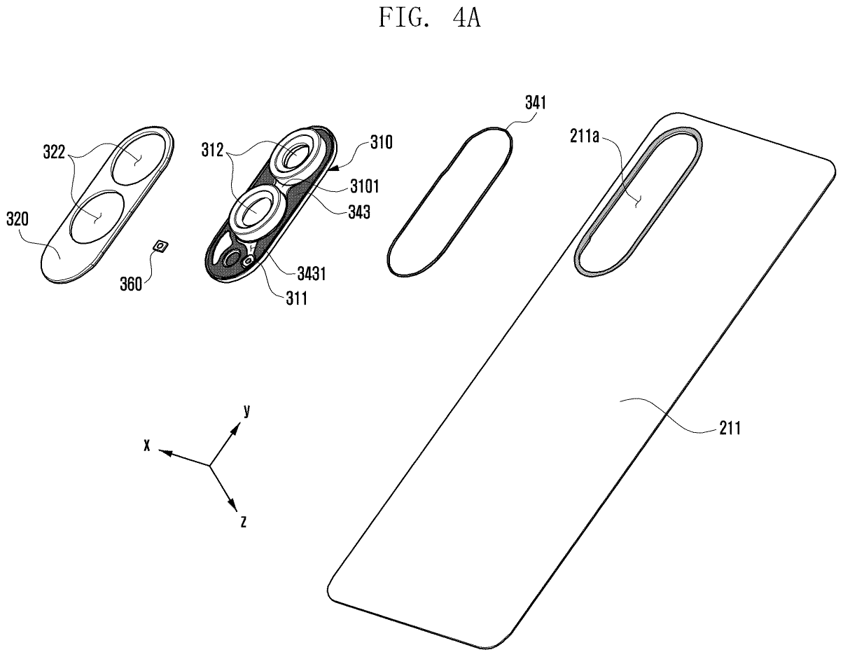

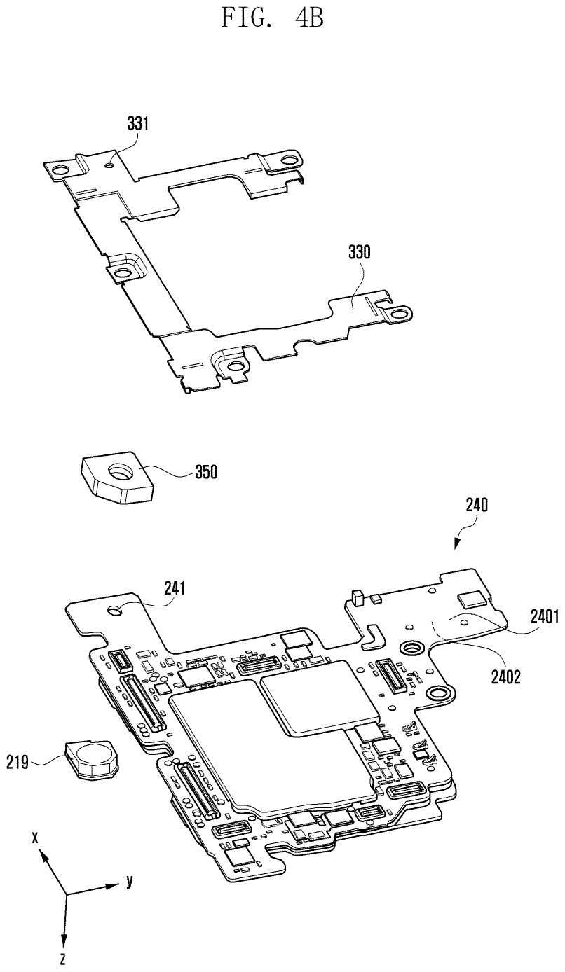

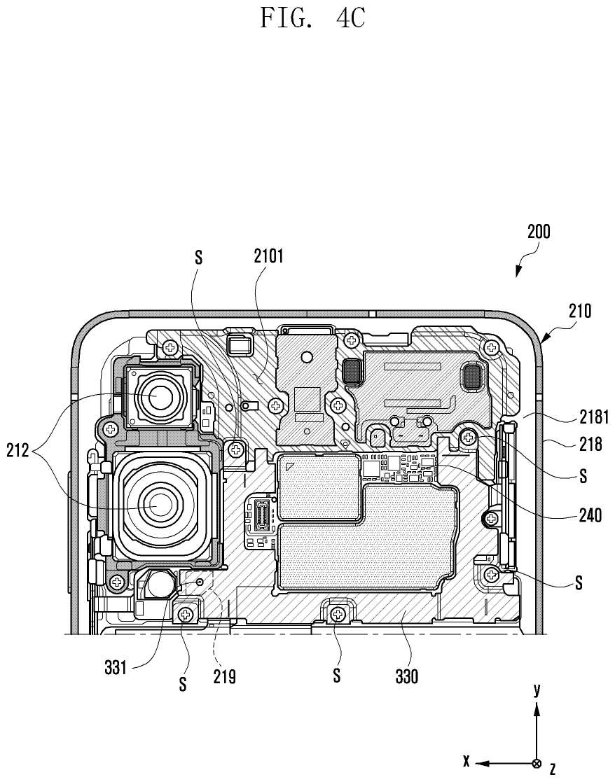

FIG. 4A is an exploded perspective view of a cover member mounted on a rear surface cover according to various example embodiments.

With reference to FIG. 4A, the rear surface cover 211 may include a first opening 211a connected with the internal space 2101 of the electronic device 200. In an embodiment, the first opening 211a may be closed through the first cover 310 attached through an adhesive member (e.g., including an adhesive) 341 (e.g., bonding) disposed on an outer surface along a periphery of the first opening 211a of the rear surface cover 211. In an embodiment, the first cover 310 may be aligned with the camera module 212 disposed in the internal space 2101 of the electronic device 200, and may include a camera exposure part 312 transparently formed to detect an external environment.

According to various embodiments, the first cover 310 may include a first surface 3101 facing an outside of the electronic device 200 and a second surface (e.g., a second surface 3102 of FIG. 6A) opposite to the first surface 3101 and facing the internal space 2101 of the electronic device 200. In an embodiment, the first cover 310 may include a first through hole 311 penetrated from the first surface 3101 to the second surface 3102 and used as an acoustic path for the microphone 219. In an embodiment, as the first through hole 311 is covered through a filter member (or filter) 360, a phenomenon of inflow of external moisture and/or foreign substances into an interior of the electronic device 200 through the first through hole 311 may be prevented and/or reduced. In an embodiment, the filter member 360 may, as a breathable waterproof member, include a membrane.

According to various embodiments, the electronic device 200 may include a second cover 320 disposed on the first surface 3101 of the first cover 310. In an embodiment, the second cover 320 may include a second opening 322 through which the camera exposure part 312 of the first cover 310 may penetrate. Accordingly, even if the second cover 320 is attached to the first cover 310, the camera exposure part 312 may be exposed to an outside of the electronic device 200 through the second opening 322. In an embodiment, the second cover 320 may be attached to the first cover 310 through the tape member 343 (e.g., a second tape member 343 of FIG. 6A). In such a case, the tape member 343 may provide a path 3431 (e.g., an acoustic transmission path) connected from a first through hole 311 to a specific space (e.g., the space 3201 of FIG. 2B) provided between the first cover 310 and the second cover 320. In an embodiment, the path 3431 may be provided through a shape change of the tape member 343. Even in such a case, the tape member 343 may be formed in a closed-loop shape surrounding the first through hole 311.

FIG. 4B is an exploded perspective view of a substrate and a metal plate according to various example embodiments. FIG. 4C is a diagram illustrating a part of a rear surface of an electronic device according to various example embodiments.

With reference to FIG. 4B and FIG. 4C, the electronic device 200 may include a substrate 240 disposed in an internal space 2101. In an embodiment, the substrate 240 may include a third surface 2401 facing a second surface 3102 of the first cover 310 and a fourth surface 2402 facing a support member (e.g., the support member 2181 of FIG. 3) of the electronic device 200 opposite to the third surface 2401. In an embodiment, the substrate 240 may include a second through hole 241 penetrated (or passed through) from the third surface 2401 to the fourth surface 2402. In an embodiment, the substrate 240 may include the microphone 219 disposed on the fourth surface 2402 and aligned with the second through hole 241.

According to various embodiments, the electronic device 200 may include the metal plate 330 (e.g., a steel use stainless (SUS) plate) mounted on the third surface 2401 of the substrate 240. In an embodiment, the metal plate 330 may include a third through hole 331 for being aligned with the second through hole 241. In an embodiment, the electronic device 200 may include the compressible sealing member (or seal) 350 disposed, between the metal plate 330 and the third surface 2401 of the substrate 240, to surround the second through hole 241 and/or the third through hole 331. In an embodiment, the compressible sealing member 350 may include at least one of a sponge, poron, rubber, urethane, or silicone. In an embodiment, since the metal plate 330 should be disposed to press the compressible sealing member 350, the metal plate 330 may be fixed to the substrate 240 through at least one screw (S). Accordingly, when the metal plate 330 is fixed to the substrate 240 through the screw (S), the compressible sealing member 350 may, between the substrate 240 and the metal plate 330, firmly seal the second through hole 241 and the third through hole 331, thereby help prevention/reduction of a sound leakage phenomenon of sound transmitted to the microphone 219. In an embodiment, the metal plate 330 may also be coupled through structural coupling (e.g., a hooking structure) with the substrate 240.

According to various embodiments, when the substrate 240 is mounted on the electronic device 200, the microphone 219, the first through hole 311 of the first cover 310, the second through hole 241 of the substrate 240, and the third through hole 331 of the metal plate 330 may be aligned with each other, and may be used as an acoustic path for the microphone 219.

FIG. 5 is a partial perspective view illustrating a state in which the cover member is mounted on the rear surface cover of the electronic device according to various example embodiments.

FIG. 5 is a partial perspective view of the electronic device 200 in a state in which the second cover 320 is removed, in which the first cover 310 and the tape member 343 (e.g., a second tape member 343 of FIG. 6A) attached to the first cover 310 are illustrated.

With reference to FIG. 5, the electronic device 200 may include an acoustic path connected from the first through hole 311 to an outside of the electronic device 200. In an embodiment, the acoustic path may be formed through the tape member 343 attached to the first cover 310. In an embodiment, the acoustic path may be formed through the path 3431 formed from the filter member 360 covering the first through hole 311 of the first cover 310 to the space 3201 formed in at least a part of the first cover 310. An upper portion of the path 3431 may be covered through the second cover 320 attached to the first cover 310. Accordingly, the path 3431 may be formed through the first surface 3101 of the first cover 310, the tape member 343, and the second cover 320, and may extend to the space 3201. In an embodiment, at least a part of the space 3201 may be concealed so as not to be seen from an outside through the second cover 320.

According to various embodiments, when the electronic device 200 is assembled, the microphone 219, the first through hole 311 of the first cover 310, the second through hole 241 of the substrate 240, and the third through hole 331 of the metal plate 330 may be aligned with each other, and the first through hole 311 may be connected with the path 3431 formed through the tape member 343 between the first cover 310 and the second cover 320 and may be connected with an outside through the space 3201 between the first cover 310 and the second cover 320. Accordingly, such mutually connected paths may be used as an acoustic path for the microphone 219.

FIG. 6A is a partial cross-sectional view of the electronic device taken along line 6-6 of FIG. 5 according to various example embodiments. FIG. 6B is a partial cutaway perspective view of the electronic device taken along line 6-6 of FIG. 5 according to various example embodiments.

With reference to FIG. 6A and FIG. 6B, the electronic device 200 may include the rear surface cover 211 including the first opening 211a, the first cover 310 disposed to close the first opening 211a of the rear surface cover 211, and the second cover 320 attached to the first cover 310. In an embodiment, the electronic device 200 may include, in the internal space 2101, a camera module (e.g., the camera module 212 of FIG. 4C) disposed to be aligned with the first opening 211a. In an embodiment, the camera module 212 may be set to be exposed to an outside of the electronic device 200 through a camera exposure part (e.g., the camera exposure part 312 of FIG. 5) of the first cover 310. In an embodiment, the first cover 310 may be formed through a metal member 310a (e.g., metal) and an injection member 310b (e.g., polymer) coupled with the metal member 310a. In an embodiment, as at least a part of the metal member 310a is disposed to be exposed to an outside of the electronic device 200, to aid in providing an elegant exterior appearance of the electronic device 200. In an embodiment, the first cover 310 may be attached to an outer surface of the rear surface cover 211 through the adhesive member 341 (e.g., bonding). In such a case, at least a part of the first cover 310 may be connected with the internal space 2101 of the electronic device 200 through the first opening 211a. In an embodiment, the first cover 310 may include the first through hole 311 formed from the first surface 3101 to the second surface 3102.

According to various embodiments, the electronic device 200 may include the substrate 240 disposed in the internal space 2101. In an embodiment, the substrate 240 may be disposed to receive support of at least a part of a support member 2181 of the electronic device 200. In an embodiment, the substrate 240 may include a laminated substrate including a first substrate 240a, a second substrate 240b spaced apart from the first substrate 240a, and an interposer 240c disposed therebetween to connect the first substrate 240a and the second substrate 240b and electrically connecting first and second substrates 240a and 240b. However, without being limited thereto, the substrate 240 may also be used as a single substrate. In an embodiment, the electronic device 200 may include the microphone 219 disposed on the fourth surface 2402 of the substrate 240. In an embodiment, the substrate 240 may include the second through hole 241 aligned with the first through hole 311. In an embodiment, the microphone 219 may be disposed to be aligned with the second through hole 241 of the substrate 240, and may be disposed to collect sound through the first through hole 311 of the first cover 310 and the second through hole 241 aligned with the first through hole 311.

According to various embodiments, the electronic device 200 may include the metal plate 330 disposed between the first cover 310 and the substrate 240 and including the third through hole 331 aligned with the first through hole 311 and the second through hole 241. In an embodiment, the electronic device 200 may include the compressible sealing member 350 sealing from an outside so as to surround the second through hole 241 and the third through hole 331 between the metal plate 330 and the substrate 240. In an embodiment, the metal plate 330 may be fixed to the substrate 240 through a fastening member such as a screw (S) in order to press the compressible sealing member 350.

According to various embodiments, the metal plate 330 may be attached to the second surface 3102 of the first cover 310 through a first tape member 342. In an embodiment, the first tape member 342 may be disposed to surround the third through hole 331 and the first through hole 311. In an embodiment, the electronic device 200 may include the filter member 360 disposed on the first surface 3101 to cover the first through hole 311 of the first cover 310. In an embodiment, as the first tape member 342 and the filter member 360 are disposed on mutually opposing surfaces of the first cover 310, help may be provided in improving waterproof performance through expansion of an adhesion area of the first tape member 342.

According to various embodiments, the electronic device 200 may include the second cover 320 attached to the first surface 3101 of the first cover 310 through a second tape member 343. In an embodiment, at least a part of the second cover 320, at least a part of the second tape member 343, and at least a part of the first surface 3101 of the first cover 310 may form at least a part of an acoustic path for the microphone 219 (e.g., the path 3431 and the space 3201 of FIG. 5).

Accordingly, sound outside the electronic device 200 may be collected to the microphone 219 through a path (e.g., the path 3431 of FIG. 5) between the first cover 310, the second tape member 343, and the second cover 320, and through the first through hole 311 of the first cover 310, the third through hole 331 of the metal plate 330, and the second through hole 241 of the substrate 240.

FIG. 6C is a perspective view of a compressible sealing member according to various example embodiments.

With reference to FIG. 6C, the electronic device 200 may include the compressible sealing member (or seal) 350 disposed between the metal plate 330 and the substrate 240 and sealing to surround through holes 241 and 331. In an embodiment, the compressible sealing member 350 may include a through hole 3501 aligned with the second through hole 241 of the substrate 240 and the third through hole 331 of the metal plate 330 between the substrate 240 and the metal plate 330, and may include a plurality of layers 351, 352, 353, and 354. In an embodiment, the compressible sealing member 350 may help reduce a sound leakage phenomenon of sound transmitted to the microphone 219.

According to various embodiments, the plurality of layers 351, 352, 353, and 354 may include an elastic sponge 351 and polyethylene terephthalate (PET) 352 attached to the sponge 351 through a double-sided tape 353. In an embodiment, the sponge 351 may provide compressibility to the compressible sealing member 350 when the metal plate 330 is fixed to the substrate 240 through a screw. In an embodiment, the PET 352 may provide rigidity for reducing unintended deformation of the compressible sealing member 350. In an embodiment, the compressible sealing member 350 may include a tape having a specific thickness (e.g., a double-sided tape) laminated on the PET 352 and attached to the metal plate 330. In an embodiment, the compressible sealing member 350 may, before the metal plate 330 is fixed to the substrate 240, be temporarily fixed through a tape 353 to maintain a state in which the through hole 3501 is aligned with the third through hole 331 of the metal plate 330. In an embodiment, the compressible sealing member 350 may also include an additional tape laminated on the sponge 351 and attached to the substrate 240.

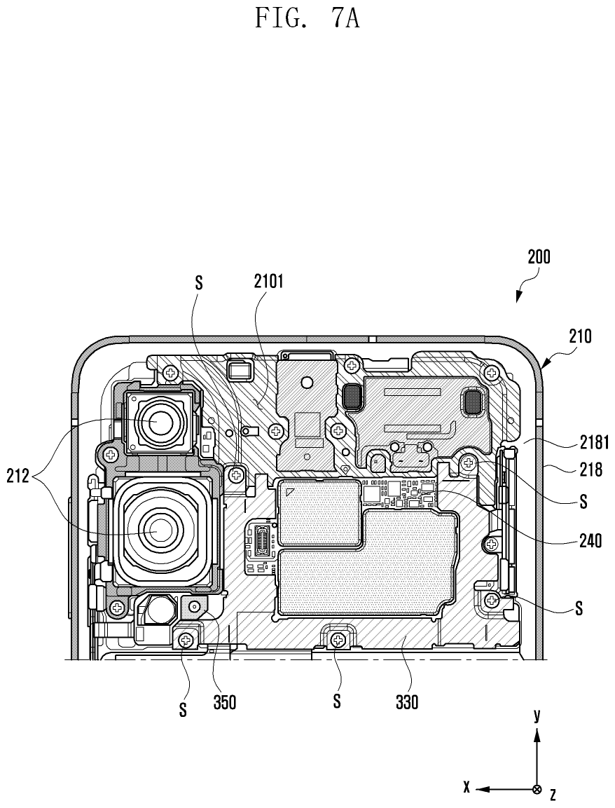

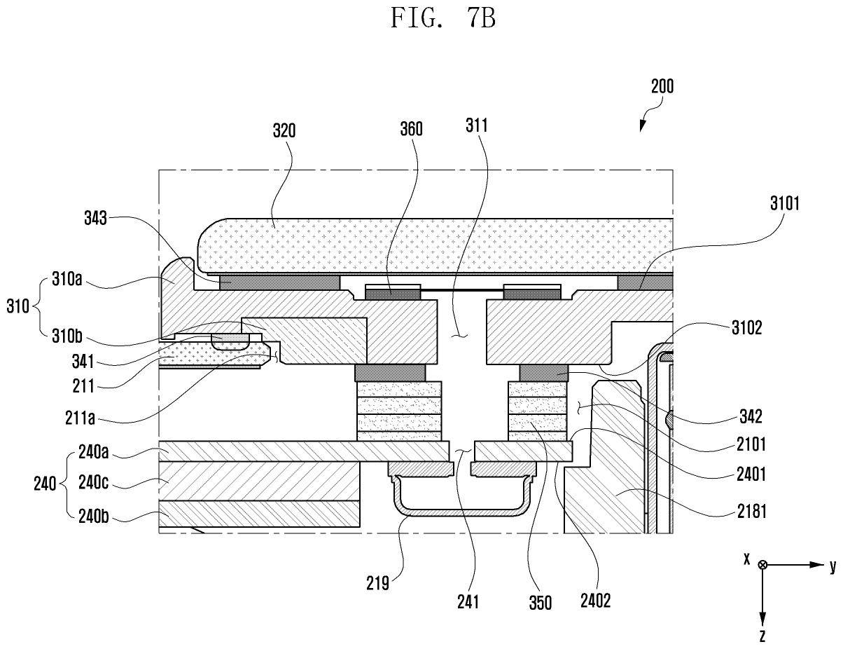

FIG. 7A is a diagram illustrating a part of a rear surface of an electronic device according to various example embodiments. FIG. 7B is a partial cross-sectional view of the electronic device illustrating a laminated structure of a microphone of FIG. 7A according to various example embodiments.

In describing the electronic device 200 of FIG. 7A and FIG. 7B, the same reference numerals are given to elements substantially the same as elements of the electronic device 200 of FIG. 4C and FIG. 6A, and a detailed description thereof may not be repeated here.

With reference to FIG. 7A and FIG. 7B, the metal plate 330 may be fixed to the substrate 240 so as not to cover the compressible sealing member 350. In an embodiment, the metal plate 330 may protect electrical elements disposed on the substrate 240, and may provide rigidity, and may perform a shielding role. In an embodiment, as a corresponding part of the metal plate 330 is omitted, the compressible sealing member 350 may be attached, through the first tape member 342, to the second surface 2102 of the first cover 310. In such a case, as the metal plate 330 is omitted in a laminated structure for an acoustic path of the microphone 219, help may be provided in slimming of the electronic device 200.

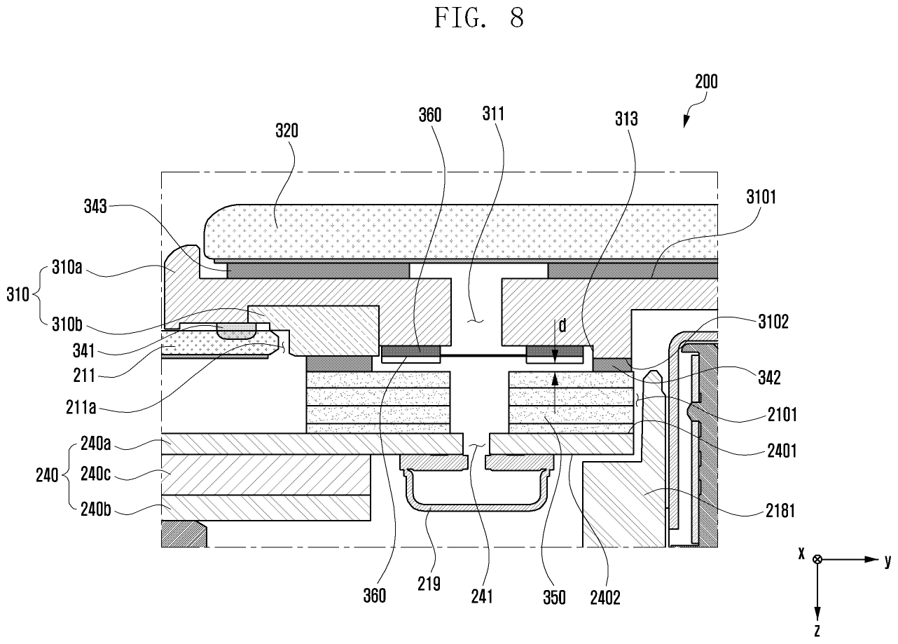

FIG. 8 is a partial cross-sectional view of an electronic device according to various example embodiments.

In describing the electronic device 200 of FIG. 8, the same reference numerals are given to elements substantially the same as elements of the electronic device 200 of FIG. 7B, and a detailed description thereof may not be repeated here.

With reference to FIG. 8, the electronic device 200 may include the first tape member 342 and the filter member 360 disposed side by side on the second surface 3102 of the first cover 310. In an embodiment, the first tape member 342 may be disposed in a manner of contacting the compressible sealing member 350 and the second surface 3102 of the first cover 310. In an embodiment, the filter member 360 may be disposed between the first through hole 311 of the first cover 310 and the first tape member 342. In an embodiment, as the filter member 360 is disposed on the second surface 3102 of the first cover 310 to be spaced apart from the compressible sealing member 350 by a specific distance (d), help may be provided in improving acoustic performance. In an embodiment, as the filter member 360 is disposed in a manner of being attached, through an adhesive member (e.g., a tape member), to a step portion 313 of the first cover 310 formed to be stepped lower than the second surface 3102 of the first cover 310, a separation distance (d) from the compressible sealing member 350 may be maintained constant. In an embodiment, the filter member 360 may be attached, in a-z-axis direction, through an adhesive member (e.g., a tape member), to the step portion 313 formed to be stepped lower than the second surface 3102 of the first cover 310.

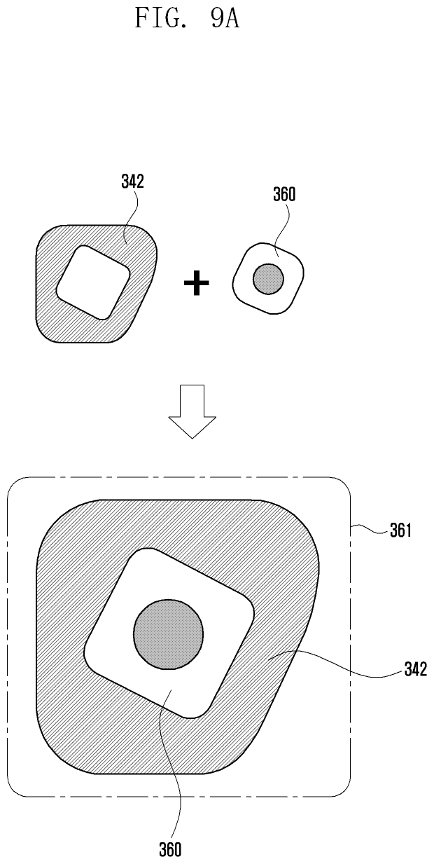

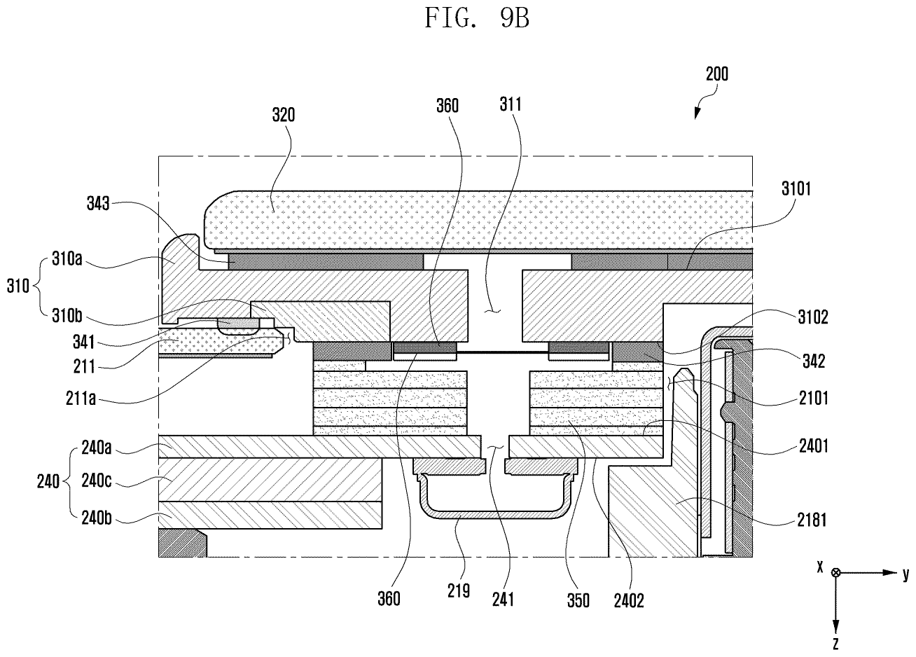

FIG. 9A is a diagram illustrating example disposition of a tape member and a filter member according to various example embodiments. FIG. 9B is a partial cross-sectional view of an electronic device in which the tape member and the filter member of FIG. 9A are disposed according to various example embodiments.

In describing the electronic device 200 of FIG. 9A and FIG. 9B, the same reference numerals are given to elements substantially the same as elements of the electronic device 200 of FIG. 8, and a detailed description thereof may not be repeated here.

With reference to FIG. 9A and FIG. 9B, when the first tape member 342 and the filter member 360 are disposed side by side on the second surface 3102 of the first cover 310, assemblability and/or attachability may be difficult. Accordingly, the first tape member 342 and the filter member 360 according to an example embodiment of the present disclosure may, after being attached in an aligned state with each other through one release paper 361, be attached to the second surface 3102 of the first cover 310. In an embodiment, after the first tape member 342 and the filter member 360 are attached to the second surface 3102 of the first cover 310, the release paper 361 may be peeled off. Accordingly, since the first tape member 342 and the filter member 360 pre-aligned through the release paper 361 are attached to the second surface 3102 of the first cover 310 in a single process, the number of assembly processes is simplified, and assemblability may be improved.

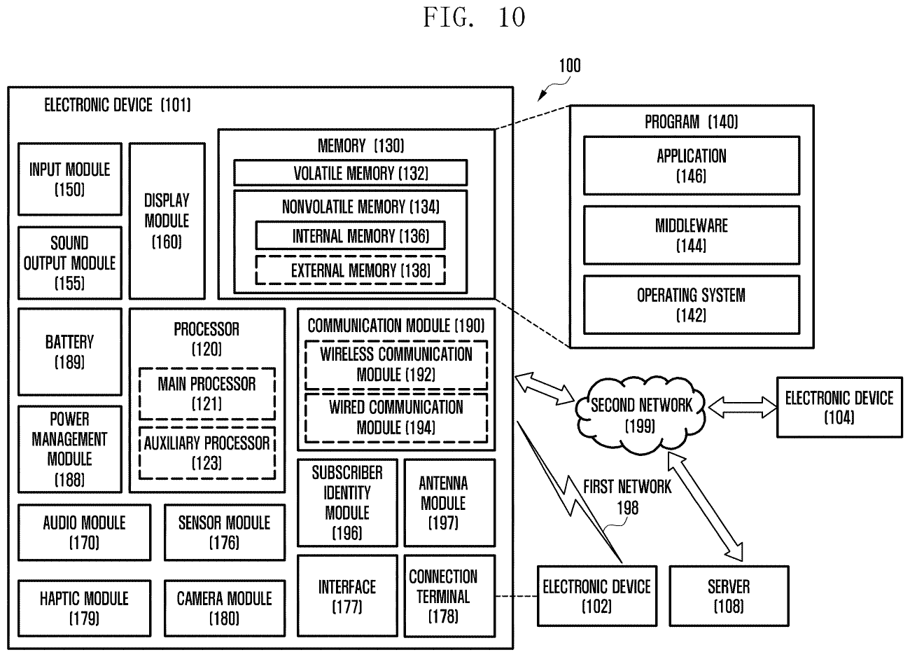

FIG. 10 is a block diagram illustrating an example electronic device 101 in a network environment 100 according to various example embodiments.

Referring to FIG. 10, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 ora headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to various example embodiments, an electronic device may include a housing (e.g., the housing 210 of FIG. 2) including a first opening (e.g., the first opening 211a of FIG. 6A), a first cover (e.g., the first cover 310 of FIG. 6A) attached to an outer surface of the housing 210 to close the first opening 211a and including a first through hole (e.g., the first through hole 311 of FIG. 6A) formed from a first surface (e.g., the first surface 3101 of FIG. 6A) facing an outside of the housing 210 to a second surface (e.g., the second surface 3102 of FIG. 6A) opposite to the first surface 3101, a substrate (e.g., the substrate 240 of FIG. 6A) disposed in the housing 210 and formed from a third surface (e.g., the third surface 2401 of FIG. 6A) facing the second surface 3102 to a fourth surface (e.g., the fourth surface 2402 of FIG. 6A) opposite to the third surface 2401 and including a second through hole (e.g., the second through hole 241 of FIG. 6A) aligned with the first through hole 311, a first electrical component (e.g., the microphone 219 of FIG. 6A) disposed on the substrate 240 and connected with an outside of the electronic device 200 through the first through hole 311 and the second through hole 241, a compressible sealing member (e.g., the compressible sealing member 350 of FIG. 6A) disposed between the third surface 2401 and the second surface 3102 to surround the first through hole 311 and the second through hole 241, and a metal plate (e.g., the metal plate 330 of FIG. 6A) disposed at least partially between the compressible sealing member 350 and the second surface 3102 and including a third through hole 331 aligned with the first through hole 311 and the second through hole 241, and the first electrical component 219 may be connected with an outside of the electronic device 200 through first, second, and third through holes 311, 241, and 331.

According to various example embodiments, the electronic device may include a first tape member (e.g., the first tape member 342 of FIG. 6A) disposed, between the second surface 3102 and the metal plate 330, to surround the first through hole 311.

According to various example embodiments, the electronic device may include a filter member (e.g., the filter member 360 of FIG. 6A) disposed, on the first surface 3101, to cover the first through hole 311.

According to various example embodiments, the electronic device may include the filter member 360 disposed, on the second surface 3102, side by side with the first tape member 342 to cover the first through hole 311.

According to various example embodiments, the filter member 360 may be disposed between the first tape member 342 and the first through hole 311.

According to various example embodiments, the electronic device may include a second cover (e.g., the second cover 320 of FIG. 6A) attached to the first cover 310 through a second tape member (e.g., the second tape member 343 of FIG. 6A) to close the first through hole 311 at least partially.

According to various example embodiments, the second tape member 343 may be formed in a shape including a path (e.g., the path 3431 of FIG. 5) extended from the first through hole 311 to a space 3201 between the first cover 310 and the second cover 320.

According to various example embodiments, the first cover 310 may include at least one camera exposure part (e.g., the camera exposure part 312 of FIG. 4A) aligned with at least a part of the first opening 311, and the at least one camera exposure part 312 may be exposed to an outside of the electronic device 200 through a second opening (e.g., the second opening 322 of FIG. 4A) formed in the second cover 320.

According to various example embodiments, the electronic device may include, in the housing 210, a second electrical component aligned with the first opening 211a and the at least one camera exposure part 312.

According to various example embodiments, the second electrical component may include at least one camera (e.g., the camera module 212 of FIG. 2) detecting an external environment through the camera exposure part 312.

According to various example embodiments, the first electrical component may include a microphone (e.g., the microphone 219 of FIG. 6A).

According to various example embodiments, the first cover 310 may be attached to an outer surface of the housing 210 through a liquid-type adhesive member (e.g., the adhesive member 341 of FIG. 6A) applied and then cured.

According to various example embodiments, the housing 210 may include a front surface cover (e.g., the front surface plate 202 of FIG. 1), a rear surface cover (e.g., the rear surface cover 211 of FIG. 6A), and a lateral member (e.g., the lateral member 218 of FIG. 6A) surrounding a space between the front surface cover 202 and the rear surface cover 211 (e.g., the internal space 2101 of FIG. 6A), and the first opening 311 may be formed in at least a part of the rear surface cover 211.

According to various example embodiments, the electronic device may include a display (e.g., the display 201 of FIG. 6B) disposed in the space 2101 and disposed to be visible from an outside through the front surface cover 202.

According to various example embodiments, the metal plate 330 may be fixed to the substrate 240.

According to various example embodiments, the compressible sealing member 350 may include a sponge, rubber, silicone, or poron.

According to various example embodiments, an electronic device may include a housing 210 including a first opening 211a, a first cover 310 attached to an outer surface of the housing 210 to close the first opening 211a and including a first through hole 311 formed from a first surface 3101 facing an outside of the housing 210 to a second surface 3102 opposite to the first surface 3101, a substrate 240 disposed in the housing 210 and formed from a third surface 2401 facing the second surface 3102 to a fourth surface 2402 opposite to the third surface 2401 and including a second through hole 241 aligned with the first through hole 311, a first electrical component 219 disposed on the substrate 240 and connected with an outside of the electronic device 200 through the first through hole 311 and the second through hole 241, and a compressible sealing member 350 disposed between the third surface 2401 and the second surface 3102 to surround the first through hole 311 and the second through hole 241, and the first electrical component 219 may be connected with the outside of the electronic device 200 through the first through hole 311 and the second through hole 241.

According to various example embodiments, the electronic device may include a filter member 360 disposed, on the first surface 3101, to cover the first through hole 311.

According to various example embodiments, the electronic device may include a first tape member 342 disposed, between the second surface 3102 and the compressible sealing member 350, to surround the first through hole 311, and may include the filter member 360 disposed, on the second surface 3102, side by side with the first tape member 342 to surround the first through hole 311.

According to various example embodiments, the electronic device may include a second cover 320 attached to the first cover 310 through a second tape member 343 to close the first through hole 311 at least partially, and the second tape member 343 may be formed in a shape including a path 3431 extended from the first through hole 311 to a space 3201 between the first cover 310 and the second cover 320.

Further, the embodiments of the present disclosure disclosed in the present specification and illustrated in the drawings are provided as particular examples for easily explaining the technical contents according to the embodiment of the present disclosure and helping understand the embodiment of the present disclosure, but not intended to limit the scope of the embodiment of the present disclosure. Accordingly, the scope of the various embodiments of the present disclosure should be interpreted as including all alterations or modifications derived from the technical teachings of the various embodiments of the present disclosure in addition to the disclosed embodiments.

What is claimed is:

1. An electronic device, comprising:
a housing including a first opening;
a first cover attached to an outer surface of the housing to close the first opening, and including a first through hole formed from a first surface facing an outside of the housing to a second surface opposite to the first surface;
a substrate disposed in the housing, and including a second through hole formed from a third surface facing the second surface to a fourth surface opposite to the third surface, the second through hole being aligned with the first through hole;
a first electrical component disposed on the substrate and connected with an outside of the electronic device through the first through hole and the second through hole;
a compressible sealing member disposed between the third surface and the second surface to surround the first through hole and the second through hole; and
a metal plate disposed at least partially between the compressible sealing member and the second surface, and including a third through hole aligned with the first through hole and the second through hole,
wherein the first electrical component is connected with the outside of the electronic device through first, second, and third through holes.

2. The electronic device of claim 1, comprising:
a first tape member disposed between the second surface and the metal plate to surround the first through hole.

3. The electronic device of claim 2, comprising:
a filter member disposed on the first surface to cover the first through hole.

4. The electronic device of claim 2, comprising:
a filter member disposed on the second surface side by side with the first tape member to cover the first through hole.

5. The electronic device of claim 4, wherein the filter member is disposed between the first tape member and the first through hole.

6. The electronic device of claim 2, comprising:
a second cover attached to the first cover through a second tape member to at least partially close the first through hole.

7. The electronic device of claim 6, wherein the second tape member has a shape including a path extending from the first through hole to a space between the first cover and the second cover.

8. The electronic device of claim 6, wherein the first cover includes at least one camera exposure part aligned with at least a part of the first opening, and
wherein the at least one camera exposure part is exposed to an outside of the electronic device through a second opening in the second cover.

9. The electronic device of claim 8, comprising:
a second electrical component aligned with the first opening and the at least one camera exposure part in the housing.

10. The electronic device of claim 9, wherein the second electrical component includes at least one camera configured to detect an external environment through the camera exposure part.

11. The electronic device of claim 1, wherein the first electrical component includes a microphone.

12. The electronic device of claim 1, wherein the first cover is attached to an outer surface of the housing through an adhesive member including a cured liquid-type adhesive.

13. The electronic device of claim 1, wherein the housing includes a front surface cover, a rear surface cover, and a lateral member surrounding a space between the front surface cover and the rear surface cover, and
wherein the first opening is provided in at least a part of the rear surface cover.

14. The electronic device of claim 13, comprising:
a display disposed in the space and disposed to be visible from an outside through the front surface cover.

15. The electronic device of claim 1, wherein the metal plate is fixed to the substrate.

16. The electronic device of claim 1, wherein the compressible sealing member includes at least one of a sponge, rubber, silicone, or poron.

17. An electronic device, comprising:
a housing including a first opening;
a first cover attached to an outer surface of the housing to close the first opening, the first cover including a first through hole formed from a first surface facing an outside of the housing to a second surface opposite to the first surface;
a substrate disposed in the housing and formed from a third surface facing the second surface to a fourth surface opposite to the third surface, the substrate including a second through hole aligned with the first through hole;
a first electrical component disposed on the substrate and connected with an outside of the electronic device through the first through hole and the second through hole; and
a compressible sealing member disposed between the third surface and the second surface to surround the first through hole and the second through hole,
wherein the first electrical component is connected with the outside of the electronic device through the first through hole and the second through hole.

18. The electronic device of claim 17, further comprising a filter member disposed on the first surface to cover the first through hole.

19. The electronic device of claim 17, further comprising a first tape member disposed between the second surface and the compressible sealing member to surround the first through hole; and
a filter member disposed on the second surface side by side with the first tape member to surround the first through hole.

20. The electronic device of claim 17, further comprising a second cover attached to the first cover through a second tape member to close the first through hole at least partially,
wherein the second tape member is formed in a shape including a path extended from the first through hole to a space between the first cover and the second cover.
